(19) United States
(12) Patent Application Publication
(10) Pub. No.: US 2025/0201246 A1
(43) Pub. Date: Jun. 19, 2025

(54) METHOD, DEVICE, AND MEDIUM FOR SPEECH INTERACTION

(71) Applicant: Beijing Youzhuju Network Technology Co., Ltd., Beijing (CN)

(72) Inventors: Bing Yang, Beijing (CN); Hongxu Xu, Beijing (CN); Chen Li, Beijing (CN)

(21) Appl. No.: 18/978,479

(22) Filed: Dec. 12, 2024

(30) Foreign Application Priority Data
Dec. 13, 2023 (CN) 202311717782.6

(51) Int. Cl. G10L 15/22; G10L 15/08

(52) U.S. Cl. CPC G10L 15/22; G10L 15/08

(57) ABSTRACT

Embodiments of the present disclosure provide a method, a device, and a medium for speech interaction. The method includes: obtaining query information of a query text corresponding to user speech using a generative language model; obtaining, based on the query information and a token sequence, a first representation sequence of the token sequence using the generative language model, wherein the token sequence is output in a streaming manner by a large language model based on the query text; encoding the token sequence using a language encoding model to obtain a second representation sequence; and combining the first representation sequence and the second representation sequence to generate an answer speech for the user speech.

### CROSS-REFERENCE TO RELATED APPLICATION(S)

This application claims priority to Chinese Patent Application No. 202311717782.6, filed with the China National Intellectual Property Administration on Dec. 13, 2023, the disclosure which is incorporated by reference in its entirety.

### FIELD

The present disclosure relates to the field of computer technologies, and in particular, to a method, a device, and a computer-readable storage medium for speech interaction.

### BACKGROUND

Text-to-speech (TTS) refers to a system which converts text or text-related tokens into speech. Currently, in the industry, TTS front-end systems based on language encoding models (for example, bidirectional encoder representations from transformers (BERT)) are used, where text or tokens are input to the language encoding models to obtain their representation sequences, which are then passed through a post-network for sequence labeling or classification to obtain final pronunciation, prosody, and normalization results.

With the rise of large language models (LLMs), LLM-based speech interaction systems are gaining increasing attention. Generation of LLM-based interaction reply content is a slow process, and is generally performed in a streaming manner. In addition, the reply content is closely related to query text. However, the language encoding models cannot use previous texts and query information of the reply content, which limits the performance of the LLM-based speech interaction systems.

### SUMMARY

According to a first aspect of the present disclosure, a method for speech interaction is provided. The method includes: obtaining query information of a query text corresponding to user speech using a generative language model; obtaining, based on the query information and a token sequence, a first representation sequence of the token sequence using the generative language model, wherein the token sequence is output in a streaming manner by a large language model based on the query text; encoding the token sequence using a language encoding model to obtain a second representation sequence; and combining the first representation sequence and the second representation sequence to generate an answer speech for the user speech.

According to a second aspect of the present disclosure, there is provided an apparatus for speech interaction. The apparatus includes: a query information obtaining unit configured to obtain query information of a query text corresponding to user speech using a generative language model; a first representation sequence obtaining unit configured to obtain, based on the query information and a token sequence, a first representation sequence of the token sequence using the generative language model, wherein the token sequence is output in a streaming manner by a large language model based on the query text; a second representation sequence obtaining unit configured to encode the token sequence using a language encoding model to obtain a second representation sequence; and a combination unit configured to combine the first representation sequence and the second representation sequence to generate an answer speech for the user speech.

According to a third aspect of the present disclosure, there is provided a computing device. The computing device includes: at least one processing unit and at least one memory, where the at least one memory is coupled to the at least one processing unit, and stores instructions executable by the at least one processing unit, and the instructions, when executed by the at least one processing unit, cause the computing device to perform the method according to the first aspect of the present disclosure.

According to a fourth aspect of the present disclosure, there is provided a non-transitory computer storage medium including machine-executable instructions that, when executed by a device, cause the device to perform the method according to the first aspect of the present disclosure.

According to a fifth aspect of the present disclosure, there is provided a computer program product including machine-executable instructions that, when executed by a device, cause the device to perform the method according to the first aspect of the present disclosure.

It should be understood that the content described in this section is not intended to identify critical or important features of the embodiments of the present disclosure, and is not used to limit the scope of the present disclosure. Other features of the present disclosure will be easily understood through the following description.

### BRIEF DESCRIPTION OF THE DRAWINGS

The foregoing and other features, advantages and aspects of embodiments of the present disclosure become more apparent with reference to the following detailed description and in conjunction with the accompanying drawings. In the drawings, the same or similar reference numerals denote the same or similar elements.

FIG. 1 is a block diagram of an environment in which a plurality of embodiments of the present disclosure can be implemented;

FIG. 2 is a block diagram of an example structure of a speech interaction system according to an embodiment of the present disclosure;

FIG. 3 is a schematic flowchart of a method for speech interaction according to an embodiment of the present disclosure;

FIG. 4 is a schematic flowchart of a data processing process according to an embodiment of the present disclosure;

FIG. 5 is a schematic block diagram of an apparatus for speech interaction according to an embodiment of the present disclosure; and

FIG. 6 is a block diagram of a computing device capable of implementing some implementations of the present disclosure.

Throughout the drawings, the same or similar reference numerals denote the same or similar elements.

### DETAILED DESCRIPTION OF EMBODIMENTS

Exemplary embodiments of the present disclosure are described below with reference to the accompanying drawings. Various details of the embodiments of the present disclosure are included to facilitate understanding and should be considered merely exemplary. Accordingly, it should be appreciated by those of ordinary skill in the art that various changes and modifications can be made to the embodiments described herein without departing from the scope and spirit of the present disclosure. Likewise, descriptions of well-known functions and structures are omitted from the following description for clarity and conciseness.

In the description of the embodiments of the present disclosure, the term “include” and similar terms should be understood as open-ended inclusion, namely, “including but not limited to”. The term “based on” should be understood as “at least partially based on”. The term “an embodiment” or “the embodiment” should be understood as “at least one embodiment”. The terms “first”, “second”, and the like may refer to different objects or the same object. Other explicit and implicit definitions may be included below.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may also include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

As used herein, the term “model” refers to a model that can learn a corresponding association between an input and an output from training data, so that after training is completed, the model can generate a corresponding output for a specific input. The model may be generated based on machine learning technologies. Deep learning is a machine learning algorithm, which processes an input and provides a corresponding output using a plurality of layers of processing units. A neural network model is an example of a model based on deep learning. In this specification, a “model” may also be referred to as a “machine learning model”, a “learning model”, a “machine learning network”, or a “learning network”, and these terms are used interchangeably herein.

A “neural network” is a type of machine learning network based on deep learning. The neural network can process an input and provide a corresponding output, and generally includes an input layer, an output layer, and one or more hidden layers between the input layer and the output layer. A neural network used in a deep learning application typically includes a large number of hidden layers, so that the depth of the network is increased. The layers of the neural network are connected in sequence, so that an output of a previous layer is provided as an input of a next layer. The input layer receives an input of the neural network and an output of the output layer serves as a final output of the neural network. Each layer of the neural network includes one or more nodes (also referred to as processing nodes or neurons), each of which processes an input from a previous layer.

Generally, machine learning may be roughly divided into three phases, namely, a training phase, a testing phase, and a use phase (also referred to as an inference phase). During the training phase, a given model may be trained on a large amount of training data, and its parameter values are continuously iterated and updated until consistent inferences that meet expected objectives can be obtained from the training data through the model. It can be considered that training enables the model to learn from the training data an association between an input and an output (also referred to as a mapping from the input to the output). The parameter values of the trained model are determined. During the testing phase, a testing input is applied to the trained model to test whether the model can provide a correct output, thereby determining the performance of the model. In some implementations, the testing phase may be omitted. During the use phase, the model may be used to process an actual input with the trained parameter values to determine a corresponding output.

As mentioned above, language models such as BERT cannot utilize previous texts and query information when encoding a current text, resulting in limited performance of a speech interaction system. In order to improve the stability of output content of the speech interaction system, some conventional methods use a long text to achieve the stability. However, in speech interaction systems based on large language models (LLMs), the LLMs output query results in a streaming manner, that is, output text or tokens word by word. When a long text is used for encoding, it is required to wait for the output of the LLMs with a longer response time, seriously affecting the user experience.

In view of this, an embodiment of the present disclosure provides a technical solution for speech interaction. The present disclosure provides a technical solution for speech interaction by introducing a generative language model. It utilizes query information input to a speech interaction system to enhance the representation sequence fed into a post-network. This approach improves the stability of the system's outputs and reduces response time during speech interactions.

In an example method, a query text corresponding to user speech is input to a generative language model to obtain query information. The generative language model is then used to generate a representation sequence based on the query information and a token sequence that is output from a large language model in a streaming manner. The generative language model may predict a representation vector corresponding to a next token based on historical information, so that previous text information and the query information are introduced during generation of the representation sequence. The method further includes encoding the token sequence using a language encoding model to obtain another representation sequence, and combining the representation sequence from the generative language model and the representation sequence from the language encoding model. A combined representation sequence may be provided to a TTS model to generate an answer speech for the user speech.

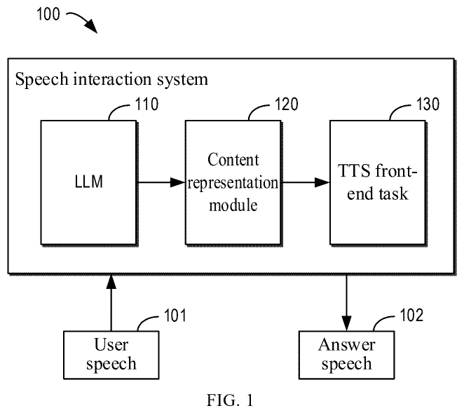

In this way, the generative language model, capable of retaining historical information, allows for the enhancement of the representation sequence input to a post-network by utilizing both query information and previous text information. This enhancement improves the stability of the speech interaction system's outputs and reduces response time during interactions. Exemplary embodiments of the present disclosure are described below with reference to FIG. 1 to FIG. 6.

FIG. 1 is a block diagram of an example environment in which a plurality of embodiments of the present disclosure can be implemented. The example environment includes a speech interaction system 100, which may be deployed on any device with computing capabilities, such as a terminal device (e.g., a mobile device, a personal computer, etc.) or a server (e.g., a stand-alone server or a cloud server, etc.). It should be understood that the components and the arrangement in the environment shown in FIG. 1 are merely examples, and a computing system suitable for implementing the example implementations described in the present disclosure may include one or more different components, other components, and/or different arrangement manners.

In operation, a user speaks to produce user speech 101 and initiates a query, and expects an answer from the speech interaction system 100. In some implementations, a sound of the user's speech may be received by a microphone in an environment where the user is located and may form the user speech 101. Depending on a specific implementation of the speech interaction system 100, the speech interaction system 100 may obtain the user speech 101 locally when it is deployed at the terminal device on the user side, or the speech interaction system 100 may obtain the user speech 101 via a network when it is deployed on the server side.

As shown in the figure, the speech interaction system 100 may include a large language model (LLM) 110, a content representation module 120, and a TTS front-end task 130. In response to the user speech 101 being obtained, the LLM 110 may generate content based on the query information carried by the user speech 101. For example, LLM 110 may be a generative pre-trained transformer (GPT) model or another type of content generation model. In some implementations, text information of the speech may be recognized from the user speech 101, the text information is provided to the LLM 110, and the LLM 110 generates answer content based on the text information. The answer content may be, for example, a text or a text-related token sequence. A token of the token sequence includes but is not limited to a phoneme, a grapheme, a morpheme, a word, etc. It should be noted that the LLM 110 may generate the token sequence in a streaming manner. In other words, the LLM 110 generates the tokens one by one over time to form the token sequence.

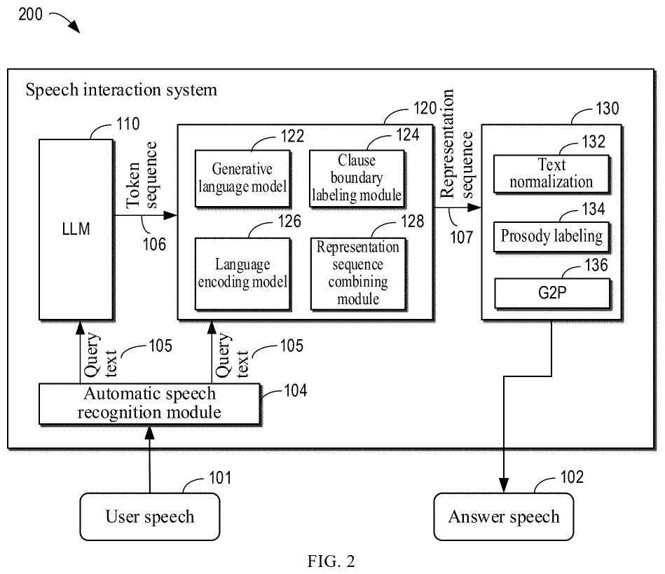

The token sequence may be provided to the content representation module 120. The content representation module 120 is configured to encode the token sequence to generate a sequence of representation vectors (referred to as representations for short). For example, the content representation module 120 may encode the token sequence using a pre-trained encoding model such as bidirectional encoder representations from transformers (BERT). Specifically, the content representation module 120 may segment the token sequence into a plurality of subsequences (e.g., perform sentence segmentation), and each subsequence is encoded by the pre-trained encoding model to generate a corresponding representation vector for each token in the subsequence. Thus, the content representation module 120 may generate a representation sequence corresponding to the token sequence, which includes a representation sequence of each token subsequence. It should be noted that, although some pre-trained encoding models can learn context information of tokens of the current sequence, they cannot utilize previous text information (for example, a previous token sequence) and query information due to limitations in their structures or characteristics. In some implementations, the content representation module 120 may further include another model for capturing the previous text information and the query information, thereby enhancing the representation sequence output by the content representation module 120, which will be described in detail below with reference to FIG. 2 to FIG. 5.

The TTS front-end task 130 may obtain the representation sequence from the content representation module 120 and perform a corresponding task based on the representation sequence. In some implementations, the TTS front-end task 130 may include but is not limited to text normalization, prosody labeling, grapheme-to-phoneme (G2P), etc. Then, the speech interaction system 100 may further generate an answer speech 102 for the user speech 101 based on an output of the TTS front-end task 130. It can be understood that the above scenario is only exemplary, and the embodiments of the present disclosure are also applicable to any other application scenarios. Some specific implementations for the speech interaction system in the present disclosure will be discussed in more detail below.

FIG. 2 is a block diagram of an example structure of a speech interaction system 200 according to an embodiment of the present disclosure. The speech interaction system 200 may be considered as an exemplary implementation of the system 100 shown in FIG. 1. As shown in the figure, the speech interaction system 200 includes an automatic speech recognition module 104, a large language model (LLM) 110, a content representation module 120, and a TTS front-end task 130. It can be understood that the speech interaction system shown in FIG. 2 is merely exemplary, in which some of the modules may be omitted or modified, and other modules may further be included.

The automatic speech recognition module 104 is configured to recognize content of user speech 101 and generate a query text 105. In some implementations, the automatic speech recognition module 104 may include a feature extraction module, a statistical acoustic model, and a language model. The feature extraction module extracts a feature from the input user speech 101 for modeling of the acoustic model and for use in the decoding process. The acoustic model is configured to model basic acoustic units such as words, syllables, and phonemes to generate an acoustic model. The language model is configured to model at a word level a language for which the recognition is performed by the system. The query text 105 generated by the automatic speech recognition module 104 may be provided as a whole to the LLM 110 for generating answer content for the query text 105. In some implementations, the LLM 110 may output the answer content in a streaming manner, and the speech interaction system 200 may generate the answer speech 102 based on the answer content output by the LLM. The answer content may include a text or a text-related token sequence such as a phoneme sequence, a grapheme sequence, a morpheme sequence, or the text itself. In some implementations, the query text 105 may be provided to the content representation module 120 as enhanced information to ensure the stability and reliability of the TTS front-end task 130.

The content representation module 120 includes a generative language model 122, a clause boundary encoding module 124, a language encoding model 126, and a representation sequence combining module 128. The generative language model 122 is configured to generate a corresponding representation vector or representation vector sequence based on the text or token sequence. In some implementations, the generative language model 122 may be, for example, a generative pre-trained transformer (GPT), which uses a multi-layer transformer structure to predict a probability distribution of a next word. Therefore, the generative language model 122 can learn previous text information and use the information to predict a next representation vector. In some embodiments, the query text may be input to the generative language model 122, such that the model obtains query information of the query text. At this time, further processing may not be performed, but instead, the answer content from the LLM 110 is waited for.

The LLM 110 outputs the answer content, i.e., token sequence, in a streaming manner. Each time the generative language model 122 obtains a token in the token sequence, it can predict a next token based on the previous text information. In some embodiments, the generative language model 122 may generate a representation vector corresponding to a given token in the token sequence based on the query information and a token preceding the given token. For example, when the generative language model 122 obtains a first token in the token sequence, it may generate a representation vector of a predicted next token based on the query information and the first token. Then, when the model obtains a second token in the token sequence, it generates a representation vector of a predicted next token based on the query information and the first token, and so on. Thus, the generative language model 122 may also generate in a streaming manner a representation sequence of the token sequence generated by the LLM 110.

The clause boundary labeling module 124 is configured to segment the token sequence to generate clauses. In some embodiments, the clause boundary labeling module 124 may perform clause labeling, for example, generate for each token or the corresponding representation vector a label indicating whether a sentence is to be segmented here, based on the token sequence from the LLM 110 or the representation sequence from the generative language model 122. In some implementations, the clause boundary labeling module 124 may determine whether a sentence is to be segmented at a location using a trained model to detect whether there is a pause in tone or a semantic difference from preceding or following words.

The language encoding model 126 is configured to encode the clauses to generate a representation sequence of the clauses. The language encoding model 126 may be an encoding model such as BERT, or another model. In some embodiments, in response to the clause boundary labeling module 124 generating a sentence segmentation label, the language encoding model 126 obtains tokens of a corresponding clause and generates a code of each token in the clause, where the code may be in the form of a vector, thereby obtaining another representation sequence including the code of the tokens of the clause. Therefore, the language encoding model 126 may also output the representation sequence corresponding to the clauses of the answer content clause by clause in a streaming manner. It should be noted that, for a given token in a clause, there may be an offset between an index of a representation vector generated by the generative language model 122 and an index of a code generated by the language encoding model 126, since the generative language model 122 predicts a next token based on previous text information. In other words, the given token and its code correspond to a previous representation vector generated by the generative language model 122.

The representation sequence combining module 128 is configured to combine the representation sequence from the generative language model 122 and the representation sequence from the language encoding model 126. In some embodiments, elements of the two representation sequences are in a form of vectors, and the representation sequence combining module 128 may perform vector addition for corresponding vectors in the two sequences (which requires that the two vectors have a same dimension). Alternatively, the representation sequence combining module 128 may perform vector concatenation for corresponding vectors in the two sequences. The combination of the representation sequences may be performed clause by clause, which can reduce the response time of speech interaction.

Then, the content representation module 120 may provide a combined representation sequence to the TTS front-end task 130. In some embodiments, the TTS front-end task 130 may include any one or more of text normalization 132, prosody labeling 134, grapheme-to-phoneme conversion (G2P) 136, etc. The answer content processed by the TTS front-end task 130 may be used to generate the answer speech 102 for output.

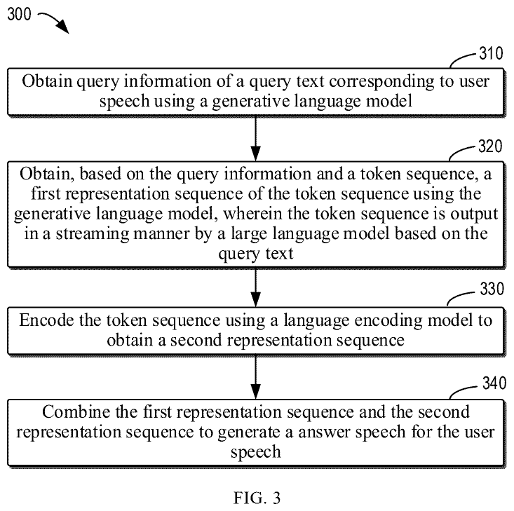

FIG. 3 is a schematic diagram of a process 400 for speech interaction according to an embodiment of the present disclosure. The process 300 may be implemented in the speech interaction systems 100 and 200 shown in FIG. 1 and FIG. 2. For ease of understanding, the process 300 will be described with reference to FIG. 2.

At block 310, query information of a query text corresponding to user speech is obtained using a generative language model. In some embodiments, the user speech 101 may be recognized as the query text 105 via the automatic speech recognition module 104 and provided to the generative language model 122. The generated query information may be retained in the generative language model 122 for subsequent use.

At block 320, based on the query information and a token sequence, a first representation sequence of the token sequence is obtained using the generative language model, wherein the token sequence is output in a streaming manner by a large language model based on the query text. In some embodiments, the query text 105 may further be provided to the LLM model 110. The LLM model 110 may generate answer content based on the query text, and output the answer content in a streaming manner. The answer content may be a text-related token sequence, where the token may be any one of a phoneme, a grapheme, a morpheme, or a word.

As mentioned above, the generative language model 122 predicts a next token based on the previous text information learned. The generative language model 122 may generate a representation vector corresponding to a given token in the token sequence based on the query information and at least one token preceding the given token.

In some embodiments, the generative language model 122 may generate the first representation sequence in a streaming manner. Specifically, the generative language model 122 obtains the first representation sequence by generating, based on the query content and tokens in the token sequence that is output in a streaming manner, representation vectors corresponding to individual tokens one by one. For example, a representation vector of the first representation sequence is generated based on the query information generated in block 310 and a token with index 1 in the token sequence, where the representation vector is denoted with index 0. Then, the generative language model 122 obtains a token with index 2, and further generates a token with index 1 in the first representation sequence based on the query information and the preceding token, and so on.

At block 330, the token sequence is encoded using a language encoding model to obtain a second representation sequence. Before being encoded, the token sequence may be segmented into clauses using the clause boundary labeling module 124. In some embodiments, the clause boundary labeling module 124 may obtain the first representation sequence output by the generative language model 122, where each representation vector corresponds to one token, and determine a clause boundary label for the token sequence based on the first representation sequence, where the clause boundary label may indicate whether a sentence is to be segmented at a location. Then, the clause boundary labeling module 124 may determine at least one consecutive token in the token sequence as a clause based on the clause boundary label. It should be noted that the token sequence is output in a streaming manner by the LLM 110, and therefore, the clauses are also generated in a streaming manner.

In response to the determination of the clause, the language encoding model 126 may obtain a token sequence of the clause generated in a streaming manner. In order to obtain the second representation sequence, the language encoding model 126 encodes the tokens in the token sequence to generate codes of these tokens, which may be in a form of vectors.

At block 340, the first representation sequence and the second representation sequence are combined to generate an answer speech for the user speech. In some embodiments, in response to the generation of the second representation sequence, the representation sequence combining module 128 may obtain the first representation sequence based on the offset between indexes of the two sequences. As an example, if an index range of the tokens of the clause is 1 to t, the indexes of the representation vectors of the first representation sequence are 0 to t−1, and the indexes of the codes in the second representation sequence are 1 to t. In some embodiments, the representation sequence combining module 128 may perform vector addition for corresponding vectors in the first representation sequence and the second representation sequence. Alternatively, the representation sequence combining module 128 may perform concatenation of the vectors.

The combined representation sequence may be provided to the TTS front-end task 130, including text normalization, prosody labeling, or grapheme-to-phoneme, etc. Then, the representation sequence processed by the front-end task may be converted into the answer speech 102 and output.

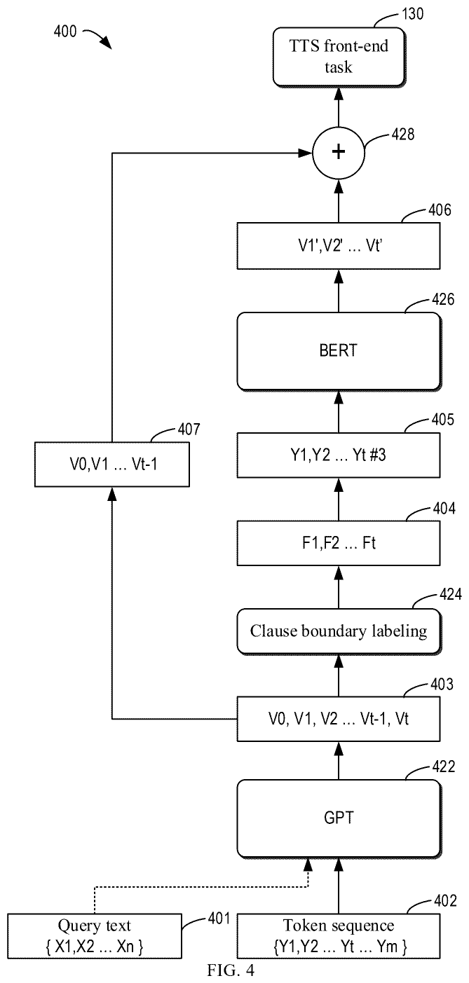

FIG. 4 is a schematic flowchart of a data processing process according to an embodiment of the present disclosure. In FIG. 4, a generative pre-trained transformer (GPT) 422 is an exemplary implementation of the generative language model 122, and bidirectional encoder representations from transformers (BERT) 426 is an exemplary implementation of the language encoding model 126. It should be understood that the present disclosure is not limited thereto, and other specific implementations are possible.

As shown in FIG. 4, a query text {X₁, X₂ . . . Xₙ} 401 is input to a GPT 422, so that the GPT 422 obtains query text information. At this time, further processing may not be performed on the result, but instead, reply content from the large language model is waited for.

Next, a token sequence {Y₁, Y₂ . . . Yₜ . . . Yₘ} 402 is input into the GPT 422 in a streaming manner as the reply content. A token Yₜ is immediately input to the GPT 422 once it is obtained, in order to obtain a corresponding representation vector Vₜ₋₁ (the GPT model predicts a next token based on previous text information, and therefore, Yₜ represents the output Vₜ₋₁ of a previous input). The GPT 422 inputs the representation vectors to clause boundary labeling module 124 in sequence to obtain boundary sequence information {F1 . . . Fₜ} 404.

When a speech interaction system continuously replies with the reply token sequence {Y₁, Y₂ . . . Yₜ . . . } 402 in a streaming manner, it may obtain a representation sequence {V₀, V₁ . . . Vₜ₋₁ . . . } 403 generated by GPT 422.

When a clause is generated based on the boundary sequence information {F1 . . . Fₜ} 404 (for example, t is a clause boundary, and Fₜ indicates sentence segmentation), a clause Y_{sub}={Y₁, Y₂ . . . Yₜ} and a corresponding representation vector sequence V={V₀, V₁ . . . Vₜ₋₁} 407 based on the GPT 422 can be obtained based on the boundary sequence information 404. Y_{sub} is input to the pre-trained BERT model 426 to obtain a second representation sequence V′={V₁′, V₂′ . . . Vₜ′} based on the BERT. The sequence 407 and the sequence 406 are added 428 to obtain a new representation sequence. Subsequently, a TTS front-end task such as normalization, prosody labeling, and pronunciation prediction may be performed based on the new representation sequence.

The above process is repeated, so that TTS front-end results may be output at a clause level, and each time the previous text information and the query text information are fully considered. In addition, when a reply speech is output at a clause level, there is no need to wait for complete reply content of an LLM, which can reduce the response time of the speech interaction system and improve the user experience.

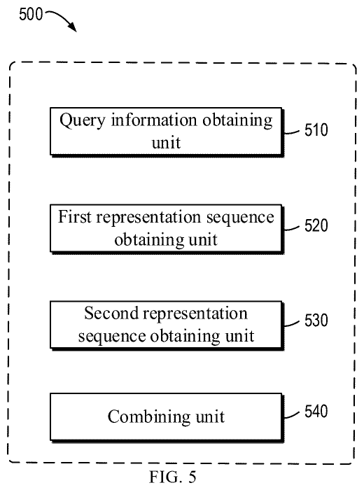

FIG. 5 is a schematic block diagram of an apparatus 500 for speech interaction according to an embodiment of the present disclosure. As shown in FIG. 5, the apparatus 500 includes: a query information obtaining unit 510, a first representation sequence obtaining unit 520, a second representation sequence obtaining unit 530, and a combining unit 540.

The query information obtaining unit 510 may be configured to obtain query information of a query text corresponding to user speech using a generative language model. The first representation sequence obtaining unit 520 may be configured to obtain, based on the query information and a token sequence, a first representation sequence of the token sequence using the generative language model, wherein the token sequence is output in a streaming manner by a large language model based on the query text; The second representation sequence obtaining unit 530 may be configured to encode the token sequence using a language encoding model to obtain a second representation sequence. The combining unit 540 may be configured to combine the first representation sequence and the second representation sequence to generate an answer speech for the user speech.

It should be noted that more actions or steps described with reference to FIG. 1 to FIG. 4 may be implemented by the apparatus 500 shown in FIG. 5. For example, the apparatus 500 may include more modules or units to implement the actions or steps described above, or some units or modules shown in FIG. 5 may be further configured to implement the actions or steps described above, which will not be repeated herein.

The exemplary embodiments of the present disclosure are described above with reference to FIG. 1 to FIG. 5. Compared with existing solutions, the technical solution provided in the present disclosure introduces a generative language model and uses query information that is input to a speech interaction system to enhance the representation sequence that is input to a post-network, thereby improving the stability of outputs of the speech interaction system and reducing the response time of speech interaction.

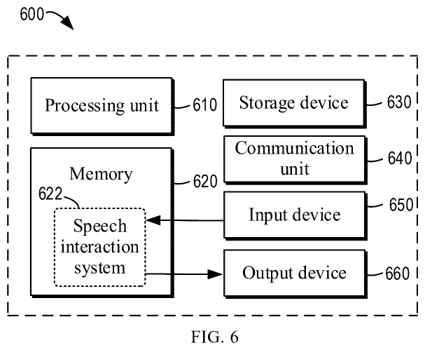

FIG. 6 is a block diagram of a computing device 600 capable of implementing a plurality of implementations of the present disclosure. It should be understood that the computing device 600 shown in FIG. 6 is merely an example and should not constitute any limitation on the functions and scope of the implementations described in the present disclosure. The computing device 600 may be configured to implement the speech interaction system 110.

As shown in FIG. 6, the computing device 600 includes a computing device 600 in a form of a general-purpose computing device. Components of the computing device 600 may include but are not limited to one or more processors or processing units 610, a memory 620, a storage device 630, one or more communication units 640, one or more input devices 650, and one or more output devices 660.

In some implementations, the computing device 600 may be implemented as various user terminals or service terminals with computing capabilities. The service terminals may be servers, large computing devices, etc., provided by various service providers. The user terminals are such as any type of mobile terminal, fixed terminal, or portable terminal, including mobile phones, stations, units, devices, multimedia computers, multimedia tablets, Internet nodes, communicators, desktop computers, laptop computers, notebook computers, netbook computers, tablet computers, personal communication system (PCS) devices, personal navigation devices, personal digital assistants (PDAs), audio/video players, digital camera/video cameras, positioning devices, television receivers, radio broadcast receivers, e-book devices, gaming devices, or any combination thereof, including accessories and peripherals of these devices or any combination thereof. It can be further contemplated that the computing device 600 can support any type of user-specific interface (such as “wearable” circuitry).

The processing unit 610 may be a physical or virtual processor, and can perform various processing based on a program stored in the memory 620. In a multi-processor system, a plurality of processing units perform computer-executable instructions in parallel, to improve a parallel processing capability of the computing device 600. The processing unit 610 may include a central processing unit (CPU), a graphics processing unit (GPU), a microprocessor, a controller, or a microcontroller.

The computing device 600 generally includes a plurality of computer storage media. Such media may be any available media accessible by the computing device 600, including, but not limited to, volatile and non-volatile media and removable and non-removable media. The memory 620 may be a volatile memory (for example, a register, a cache, or a random access memory (RAM)), a non-volatile memory (for example, a read-only memory (ROM), an electrically erasable programmable read-only memory (EEPROM), or a flash memory), or a specific combination thereof. The memory 620 may include a speech interaction system 622 configured to perform the functions of various implementations described herein. The speech interaction system 622 may be accessed and run by the processing unit 610 to implement the corresponding functions.

The storage device 630 may be a removable or non-removable medium, may include a machine-readable medium, and may be configured to store information and/or data, and accessed in the computing device 600. The computing device 600 may further include other removable/non-removable and volatile/non-volatile storage media. Although not shown in FIG. 8, a disk drive for reading from or writing into removable and non-volatile disks and an optical disc drive for reading from or writing into removable and non-volatile optical discs may be provided. In these cases, each drive may be connected to a bus (not shown) through one or more data medium interfaces.

The communication unit 640 implements communication with another computing device through a communication medium. In addition, functions of the components of the computing device 600 may be implemented by a single computing cluster or a plurality of computing machines, and these computing machines can communicate through a communication connection. Therefore, the computing device 600 may perform operations in a networked environment through a logical connection to one or more other servers, a personal computer (PC), or another general network node.

The input device 650 may be one or a plurality of various input devices, such as a mouse, a keyboard, a trackball, and a speech input device. The output device 660 may be one or more output devices, such as a display, a speaker, and a printer. The computing device 600 may further communicate, through the communication unit 640 as required, with one or more external devices (not shown), for example, a storage device and a display device, with one or more devices enabling a user to interact with the computing device 600, or with any device (for example, a network interface card or a modem) enabling the computing device 600 to communicate with one or more other computing devices. Such communication may be performed through an input/output (I/O) interface (not shown).

In some implementations, in addition to being integrated on a single device, some or all of the components of the computing device 600 may also be provided in a form of a cloud computing architecture. In the cloud computing architecture, these components may be remotely located, and may work together to implement the functions described in the present disclosure. In some implementations, cloud computing provides computing, software, data access, and storage services without requiring an end user to be aware of a physical location or configuration of a system or hardware providing these services. In various implementations, the cloud computing provides the services over a wide area network (such as the Internet) using an appropriate protocol. For example, cloud computing providers offer applications over the wide area network, which may be accessed through a web browser or any other computing component. Software or components of the cloud computing architecture and corresponding data may be stored on servers at remote locations. Computing resources in a cloud computing environment may be consolidated at a remote data center, or may be decentralized. Cloud computing infrastructures may provide services through a shared data center, even though they appear as a single access point to users. Therefore, the components and functions described herein may be provided from service providers at remote locations using the cloud computing architecture. Alternatively, they may be provided from a conventional server, or they may be installed directly or otherwise on a client device.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

Program code used to implement the method of the present disclosure may be written in any combination of one or more programming languages. The program code may be provided to a processor or a controller of a general-purpose computer, a special-purpose computer, or another programmable data processing apparatus, such that when the program code is executed by the processor or the controller, functions/operations specified in the flowcharts and/or the block diagrams are implemented. The program code may be completely or partially executed on a machine, or may be executed as an independent software package partially on a machine and partially on a remote machine, or completely on a remote machine or a server.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

In addition, although the various operations are depicted in a specific order, it should be understood as requiring such operations to be performed in the specific order shown or in a sequential order, or requiring all illustrated operations to be performed to achieve desired results. Under certain circumstances, multitasking and parallel processing may be advantageous. Similarly, although several specific implementation details are included in the foregoing discussions, these details should not be construed as limiting the scope of the present disclosure. Some features that are described in the context of separate implementations can also be implemented in combination in a single implementation. In contrast, various features described in the context of a single implementation may alternatively be implemented in a plurality of implementations individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

I/We claim:

1. A method comprising:
obtaining query information of a query text corresponding to user speech using a generative language model;
obtaining, based on the query information and a token sequence, a first representation sequence of the token sequence using the generative language model, wherein the token sequence is output in a streaming manner by a large language model based on the query text;
encoding the token sequence using a language encoding model to obtain a second representation sequence; and
combining the first representation sequence and the second representation sequence to generate an answer speech for the user speech.

2. The method according to claim 1, wherein obtaining the first representation sequence of the token sequence comprises:
generating, for a given token in the token sequence, a representation vector corresponding to the given token based on the query information and at least one token preceding the given token.

3. The method according to claim 1, wherein obtaining the first representation sequence of the token sequence comprises:
generating the first representation sequence in a streaming manner.

4. The method according to claim 1, wherein obtaining the second representation sequence comprises:
determining at least one consecutive token in the token sequence; and
generating a code of the at least one token using the language encoding model.

5. The method according to claim 4, wherein combining the first representation sequence and the second representation sequence comprises:
combining the code of the at least one token and a corresponding representation vector in the first representation sequence.

6. The method according to claim 5, wherein there is an offset between a first index of the code in the first representation sequence and a second index of the corresponding representation vector in the second representation sequence.

7. The method according to claim 4, further comprising:
determining a clause boundary label for the token sequence based on the first representation sequence; and
determining at least one consecutive token in the token sequence as a clause based on the clause boundary label.

8. The method according to claim 4, wherein the code of the at least one token and the corresponding representation are in the form of vectors, and the combining comprises:
performing addition and/or concatenation of the vectors.

9. The method according to claim 1, further comprising:
providing a combined representation sequence to a text-to-speech (TTS) front-end task, wherein the TTS front-end task comprises at least one of text normalization, prosody labeling, or grapheme-to-phoneme.

10. The method according to claim 1, wherein a token of the token sequence comprises any of a phoneme, a grapheme, a morpheme, or a word.

11. A device, comprising:
at least one processing unit; and
at least one memory, wherein the at least one memory is coupled to the at least one processing unit, and stores instructions executable by the at least one processing unit, and the instructions, when executed by the at least one processing unit, cause the computing device to perform a method comprising:
obtaining query information of a query text corresponding to user speech using a generative language model;
obtaining, based on the query information and a token sequence, a first representation sequence of the token sequence using the generative language model, wherein the token sequence is output in a streaming manner by a large language model based on the query text;
encoding the token sequence using a language encoding model to obtain a second representation sequence; and
combining the first representation sequence and the second representation sequence to generate an answer speech for the user speech.

12. The device according to claim 1, wherein obtaining the first representation sequence of the token sequence comprises:
generating, for a given token in the token sequence, a representation vector corresponding to the given token based on the query information and at least one token preceding the given token.

13. The device according to claim 11, wherein obtaining the first representation sequence of the token sequence comprises:
generating the first representation sequence in a streaming manner.

14. The device according to claim 11, wherein obtaining the second representation sequence comprises:
determining at least one consecutive token in the token sequence; and
generating a code of the at least one token using the language encoding model.

15. The device according to claim 14, wherein combining the first representation sequence and the second representation sequence comprises:
combining the code of the at least one token and a corresponding representation vector in the first representation sequence.

16. The device according to claim 15, wherein there is an offset between a first index of the code in the first representation sequence and a second index of the corresponding representation vector in the second representation sequence.

17. The device according to claim 14, further comprising:
determining a clause boundary label for the token sequence based on the first representation sequence; and
determining at least one consecutive token in the token sequence as a clause based on the clause boundary label.

18. The device according to claim 14, wherein the code of the at least one token and the corresponding representation are in the form of vectors, and the combining comprises:
performing addition and/or concatenation of the vectors.

19. The device according to claim 11, further comprising:
providing a combined representation sequence to a text-to-speech (TTS) front-end task, wherein the TTS front-end task comprises at least one of text normalization, prosody labeling, or grapheme-to-phoneme.

20. A non-transitory computer storage medium comprising machine-executable instructions which, when executed by a device, cause the device to perform a method comprising:
obtaining query information of a query text corresponding to user speech using a generative language model;
obtaining, based on the query information and a token sequence, a first representation sequence of the token sequence using the generative language model, wherein the token sequence is output in a streaming manner by a large language model based on the query text;
encoding the token sequence using a language encoding model to obtain a second representation sequence; and
combining the first representation sequence and the second representation sequence to generate an answer speech for the user speech.
